(19) United States
(12) Patent Application Publication
(10) Pub. No.: US 2004/0147652 A1
(43) Pub. Date: Jul. 29, 2004

(54) Novel radiation attenuating material and method for making same

(76) Inventors: Pierre-Marie Lemer, Nantes (FR); Francois du Laurent de la Barre, Sevres (FR)

Correspondence Address: YOUNG & THOMPSON, 745 SOUTH 23RD STREET 2ND FLOOR, ARLINGTON, VA, 22202

(21) Appl. No.: 10/478,361

(22) PCT Filed: May 21, 2002
(86) PCT No.: PCT/FR02/01707

(30) Foreign Application Priority Data
May 21, 2001 (FR) 01/06670

(51) Int. Cl. C08L 67/00; C08L 69/00

(52) U.S. Cl. 524/401; 524/408

(57) ABSTRACT

Novel radiation attenuating material made of plastic material comprising a metallic filler consisting of a combination of at least two, preferably, three metals or metal derivatives (oxides or alloys) of different type, except lead, selected on the basis of discontinuities of the X- or gamma radiation absorption curve of the metals or metal derivatives, so as to obtain complementarity of the curves on the energy range of radiation to be absorbed or attenuated, to optimise radiation protection on the energy range. The metallic filler is preferably in the form of a powder whereof the particle dimensions are for the major part less than 50 μm. The filler is present in proportions ranging between 70 and 95% of the weight of the final material and is selected preferably among dense metals such as tungsten, tin, bismuth, barium, antimony, lanthanides, tantalum or derivatives thereof, in particular oxides and alloys.

This invention relates to a new radio-attenuator material applicable in particular for the realisation of shielding(s), in the field of medical or industrial imaging using X or gamma electromagnetic beams, or within the framework of the preparation, of the use or of the storage of radioactive products transmitting X or gamma electromagnetic beams; it also relates to the method of manufacture of this material.

The radio-attenuator material used most frequently is lead, in particular by reason of its low cost, of its easy implementation by moulding, and of its good radio-attenuation qualities.

Sometimes other dense materials can be used such as tungsten, tin, bismuth or others . . . , but with relative limitations.

Thus, leaden shroud are largely used in the field of medical or industrial imaging using X or gamma electromagnetic beams (for example, shielding of the radiogenic tube, brightness amplifier or associated plane detector, in radiology installations; shielding of gamma-cameras and scanners; shielding of non-destructive control installations such as luggage control installations in airports, or others . . . ).

Such lead shrouds are also used to protect syringes for injecting radioactive products, or still to protect the containers or the vials wherein these radioactive products are conditioned.

However, the use of lead is regulated more and more strictly, by reason of its toxicity and environmental or ecological problems raised; handling this metal shows sanitary risks, and it is often very necessary to combine it with a coating such as paint or shell of plastic matter, which makes the manufacture as well as the maintenance of the shielding significantly more complicated.

The document EP-0 372 758 divulges radioprotective materials composed of a thermoplastic base loaded with metal particles. But taking their structure into account, the corresponding materials are mainly suited to the realisation of flexible or supple end products. The metal charge or the combination of charges implemented, and the size of the particles used, are not adapted to provide optimised radioprotection.

A first object of this invention is to provide a new radio-attenuator material enabling to replace the leaden walls for the manufacture of shieldings, and thereby enabling to remedy the shortcomings mentioned above of the structures known until now.

Another object of the invention is to obtain a material whereof the radio-attenuation features are improved over existing protection structures.

According to this invention, this new radio-attenuator material is formed of a plastic material comprising a charge of metal particles formed of a combination of at least two (and preferably three) metals and/or derivates of metals (oxides or alloys) of different nature, with the exception of lead, selected in relation to the discontinuities of the absorption curve of the X or gamma beams of said metals or derivates of metals (which discontinuities are due to the interactions on the various electronic layers K, L, M . . . ), in order to provide a complementarity of said curves over the energetic range of the beams that should be absorbed or attenuated, to optimise the radioprotection over this energetic range.

This association of metal particles, with the exception of lead that should be avoided absolutely, enables to obtain excellent features of radio-attenuation.

The material according to this invention is very simple to transformer into shaped parts, in particular by injection moulding techniques, after homogenous mixture of the plastic base with the metal charge. Such technique enables to obtain easily any form of chemically stable product, the metal charge included in the plastic base being made absolutely inert.

The product moulded shows very good finish quality; it should also be noted that it is possible to adapt its colour at will by means of appropriate colourings associated with the plastic base.

Any type of plastic matter may be used as a basic support, such as thermosetting matters (for example bakelite), the elastomer matters (for example fluoropropylene, silicon elastomers . . . ), rubber or resins.

Thermoplastic matters such as polyamide, polypropylene or polycarbonate are nevertheless preferred by means of their low cost or their easy implementation, notably by injection-moulding techniques.

To obtain good radio-attenuation characteristics, the metal charge accounts for between 70 and 95% in weight of the end material. This metal charge may be in the form of flakes or of fibres, but it is used preferably in the form of a powder, with particles generally spheroid in shape. In such a powder, the particle sizes are advantageously, overwhelmingly smaller than 50 μm. Preferably, at least 90% of the particles are smaller than 50 μm in size, and still preferably, at least 90% are smaller than 30 μm in size.

For the reasons mentioned above, the metal charge associated with the plastic base is selected among dense metals. For example, particles of tungsten, tin, bismuth, barium, antimony, tantalum or lanthanide, or still derivates of these different metals (oxides or alloys in particular) may be used.

The plastic base, the charge(s) used, the particle size of the charge(s), the particle rate of the charge(s) in the plastic base, as well as the end thicknesses of walls, are adapted on a case to case basis, in relation to the application contemplated and in relation to the radio-attenuation rate desired. Preferably, at least the radio-attenuation characteristics of metal lead should be reached.

### EXAMPLES OF COMPOSITION OF MOULDINGS

### Example 1 (M1)

Plastic base: polyethersulphone at the rate of 5% in weight

Charge (in the form of powder whereof the particle size is at least 90% smaller than 50 μm):

bismuth (bi): 20% in weight

antimony (sb): 28% in weight

tungsten (w): 28% in weight

Lanthane trioxide (La₂ O₃): 19% in weight

The lead equivalence of such composition is obtained with a mass thickness (in g/cm2) 25% smaller than that of the metal lead, for an X generator voltage at most equal to 100 keV.

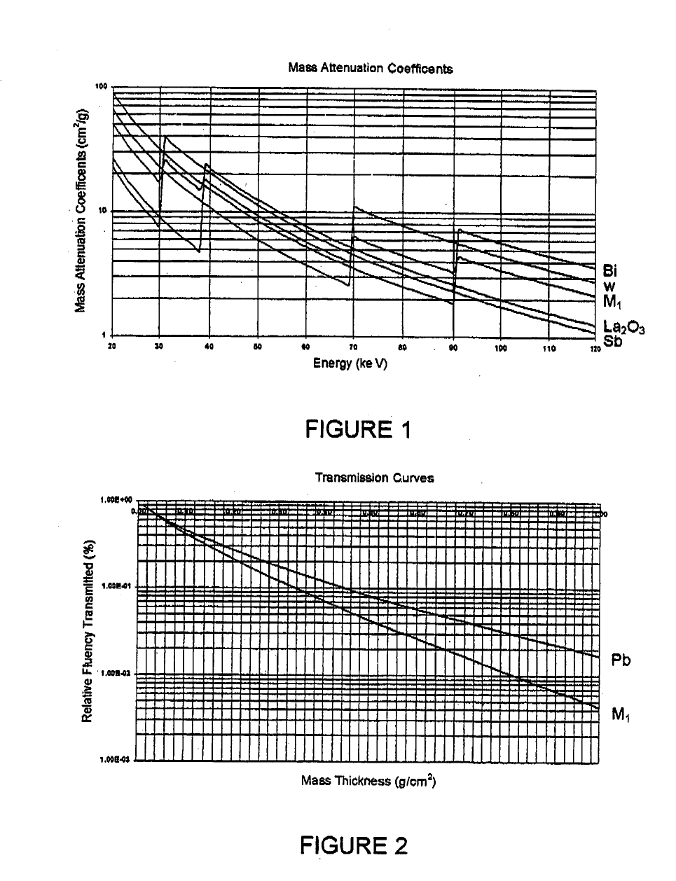

FIG. 1 appended shows the mass attenuation curves of bismuth (bi), of antimony (Sb), of tungsten (w), of Lanthane trioxide (La₂ O₃) and of a mixture (M1) of these elements according to the proportions defined above.

Such figure shows the discontinuities of the curves due to the effects of the various external electronic layers of these atoms of these elements, over the energy range of 20-120 KeV.

It can be noted that for a certain energy range, an average curve can be obtained thanks to the mixture of the elements.

FIG. 2 shows the transmission curves of lead screens (pb) and of the composite mixture (M1), in relation to the mass thickness of the screen facing a beam of an X generator with maximum voltage 100 KeV.

The fluency corresponds to the number of photons/sec./cm² going through the screen; one makes sure on these curves that the mixture (M1) is significantly more absorbent than lead for the maximum energy considered (100 KeV).

### Example 2 (M2)

Plastic base: polyamide at the rate of 26% in weight

Charge (in the form of powder whereof the particle size is at least 90% smaller than 50 μm):

bismuth trioxide (Bi₂ O₃): 15% in weight

Lanthane trioxide (La₂ O₃): 44% in weight

antimony trioxide (Sb₂ O₃); 15% in weight

The lead equivalence of such composition is obtained with a mass thickness (in g/cm2) 25% smaller than that of the metal lead, for an X generator voltage at most equal to 80 keV.

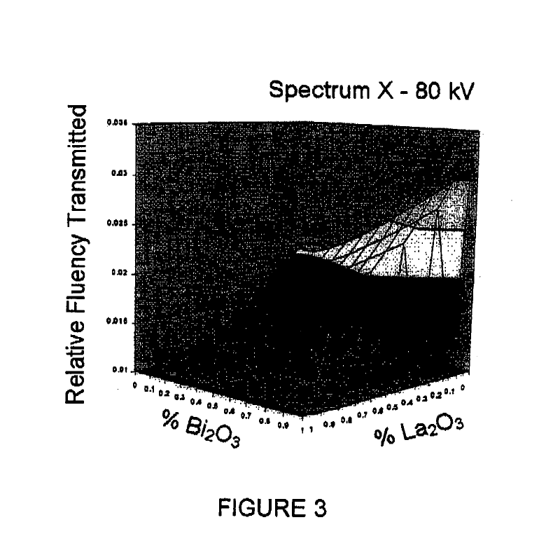

FIG. 3 appended is a threedimension representation of the fluency relative transmitted of a spectrum of 80 KeV X-rays through a screen with a mass thickness of 0,57 g/cm², composed of various percentages of Bismuth trioxide (Bi₂ O₃), of Lanthane trioxide (La₂ O₃) and of antimony trioxide (Sb₂ O₃).

The percentage of Sb₂ O₃ may be calculated by: 1-% Bi₂ O₃-% La₂ O₃.

On this Figure, the absorption is the greater that relative fluency transmitted is low. Such a representation enables to define the percentages of the three oxides which provide the best compromise: absorption efficiency—price—physical chemical characteristic of the composite.

1.- A radio-attenuator material, in particular for the realisation of shielding structures, in the field of medical or industrial imaging using X or gamma electromagnetic beams, or within the framework of the preparation, of the use or of the storage of radioactive products transmitting X or gamma electromagnetic beams, characterised in that it is composed of a plastic material comprising a charge of metal particles, which charge is formed of a combination of at least two metals and/or derivates of metals of different nature, with the exception of lead, selected in relation to the discontinuities of the absorption curve of the X or gamma beams of said metals or derivates of metals, in order to provide a complementarity of said curves over the energetic range of the beams that should be absorbed or attenuated, to optimise the radioprotection over said energetic range.

2.- A radio-attenuator material according to claim 1, characterised in that it comprises a charge composed of metal powder whereof the particle sizes are at least 90% smaller than 50 μm.

3.- A radio-attenuator material according to claim 2, characterised in that it comprises a charge composed of metal powder whereof the particle sizes are at least 90% smaller than 30 μm.

4.- A radio-attenuator material according to any of the claims 1 to 3, characterised in that it comprises a metal charge present in proportions ranging between 70% and 95% in weight of the end material.

5.- A radio-attenuator material according to any of the claims 1 to 4, characterised in that it comprises a metal charge selected among tungsten, tin, bismuth, barium, antimony, lanthanides, tantalum or the derivates thereof, in particular oxides and alloys.

6.- A radio-attenuator material according to any of the claims 1 to 5, characterised in that it comprises a base of thermoplastic matter such as polyamide, polypropylene or polycarbonate.

7.- A radio-attenuator material according to any of the claims 1 to 6, characterised in that it comprises a metal charge formed of a combination of at least three metals or derivates of metals.

8.- A method of manufacture of a radio-attenuator material according to any of the claims 1 to 7, characterised in that it consists:
in determining the metals or derivates of metals, with the exception of lead, which, over the energetic range of the beams that should be absorbed or attenuated, show absorption curves of the complementary X or gamma beams, in particular because of the discontinuities of said curves,
in selecting a combination of at least two of said metals or derivates of metals,
in preparing a homogeneous mixture of particles of said combination of metals or derivates of metals with a plastic matter, then
in forming the radio-attenuator material by moulding said mixture.

9.- An application of the material according to any of the claims 1 to 7 for the manufacture of rigid shieldings against the radiations whereof the energy is smaller than 100 keV.
